(19) United States
(12) Patent Application Publication
(10) Pub. No.: US 2022/0337085 A1
(43) Pub. Date: Oct. 20, 2022

(54) POWER SUPPLY SYSTEM FOR FLOATING MOBILE BODY OR UNDERWATER MOBILE BODY

(71) Applicant: Fujiwaves CO., LTD., Fujiyoshida-shi, Yamanashi (JP)

(72) Inventor: Ikuo AWAI, Fujiyoshida-shi, Yamanashi (JP)

(21) Appl. No.: 17/764,676

(22) PCT Filed: Sep. 29, 2020
(86) PCT No.: PCT/JP2020/036943

§ 371 Date: Mar. 29, 2022

(30) Foreign Application Priority Data
Oct. 1, 2019 (JP) 2019-181766

(51) Int. Cl. H02J 50/05; B63G 8/08

(52) U.S. Cl. CPC H02J 50/05; B63G 8/08

(57) ABSTRACT

A power supply system for a floating mobile body or an underwater mobile body moving on or under water in a water channel or a water tank is configured to supply, in a non-contact manner, power from a power transmission apparatus to a power reception apparatus. The power transmission apparatus includes an AC power source that includes a first terminal and a second terminal and outputs an AC power wave, a power transmission inductance element having one terminal connected to the first terminal, and a first power transmission electrode provided in the water channel or the water tank and having an end portion connected to another terminal of the power transmission inductance element. The power reception apparatus includes a first power reception electrode, a second power reception electrode provided apart from the first power reception electrode, and a power reception inductance element connected to the first power reception electrode.

### CROSS-REFERENCE TO RELATED APPLICATIONS

This application is the U.S. National Phase of International Application No. PCT/JP2020/036943, filed Sep. 29, 2020. That application claims priority to Japanese Patent Application No. 2019-181766, filed Oct. 1, 2019. Both of those applications are incorporated by reference herein in their entireties.

### TECHNICAL FIELD

The present invention relates to a power supply system that supplies power to a floating mobile body or an underwater mobile body in a non-contact manner.

### BACKGROUND ART

There have been known power supply systems that supply power to floating mobile bodies or underwater mobile bodies in a non-contact (wireless) manner. For example, Japanese Patent Application Laid-open No. 2010-11696 discloses a power supply system that supplies power to a ship, which is a floating mobile body, from an iron core coil on a land side by using electromagnetic induction or from an antenna by using microwaves. In addition, Japanese Patent Application Laid-open No. 2017-056161 discloses a power supply system (swimming body viewing device) that supplies power to a swimming body, which is an underwater mobile body, from a spiral coil in a water tank by resonance using a non-radiation electromagnetic field.

### BRIEF SUMMARY

However, since the power supply systems for the floating mobile body or the underwater mobile body as disclosed in Japanese Patent Application Laid-open No. 2010-11696 and Japanese Patent Application Laid-open No. 2017-056161 use an iron core coil, an antenna, or a spiral coil for power transmission, configurations of these power supply systems are not simple. In addition, a larger configuration is needed to make it possible to supply power over a long moving distance, which is not easy.

With the foregoing in view, it is an object of the present invention to provide a power supply system for a floating mobile body or an underwater mobile body, the power supply system having a simple configuration and being capable of easily supplying power over a long moving distance.

To achieve the above object, a power supply system for a floating mobile body or an underwater mobile body according to an aspect of the present invention is a power supply system capable of supplying, in a noncontact manner, power from a power transmission apparatus to a power reception apparatus of the floating mobile body or the underwater mobile body that moves on or under water in a water channel or a water tank, characterized in that the power transmission apparatus includes: an alternating-current (AC) power source that includes a first terminal and a second terminal and outputs an AC power wave; a power transmission inductance element having one terminal connected to the first terminal; and a first power transmission electrode that is provided in the water channel or the water tank and has an end portion connected to another terminal of the power transmission inductance element, and the power reception apparatus includes: a first power reception electrode; a second power reception electrode that is provided apart from the first power reception electrode; and a power reception inductance element that is connected to the first power reception electrode.

The power transmission apparatus further may include a second power transmission electrode that is provided apart from the first power transmission electrode in the water channel or the water tank and has an end portion connected to the second terminal of the AC power source. In this case, the second power transmission electrode or the second terminal may be grounded.

The first power reception electrode may be disposed so as to face the first power transmission electrode in the water channel, and the second power reception electrode is disposed above the first power reception electrode.

The first power reception electrode may be disposed so as to face the first power transmission electrode and the second power reception electrode is disposed so as to face the second power transmission electrode.

The water channel may be provided with only the first power transmission electrode, the first power transmission electrode includes an electric wire or a cable formed by bundling a plurality of the electric wires, the electric wire or the cable has a diameter smaller than that of the first power reception electrode, the first power reception electrode is disposed so as to face the electric wire or the cable, and the second power reception electrode is disposed vertically above the first power reception electrode. In this case, the second terminal of the AC power source may be grounded.

According to the present invention, a power supply system for a floating mobile body or an underwater mobile body has a simple configuration and can easily supply power over a long moving distance.

### BRIEF DESCRIPTION OF THE DRAWINGS

FIG. 1A is a sectional view taken along a section in a lengthwise direction of a water channel, illustrating an outline of a power supply system for a floating mobile body or an underwater mobile body according to an embodiment of the present invention.

FIG. 1B is a sectional view taken along a section in a width direction (direction perpendicular to the lengthwise direction) of the water channel, illustrating the outline of the power supply system described above.

FIG. 2A is an equivalent circuit diagram of the power supply system described above, illustrating capacitance values as they are.

FIG. 2B is an equivalent circuit diagram of the power supply system described above, summarizing the capacitance values in FIG. 2A.

FIG. 3A is a sectional view taken along a section in the lengthwise direction of the water channel, illustrating a configuration for an experiment on the power supply system described above.

FIG. 3B is a sectional view taken along a section in a width direction (direction perpendicular to the lengthwise direction) of the water channel, illustrating the configuration for the experiment on the power supply system described above.

FIG. 4A is a graph illustrating results of the experiment on the power supply system described above, indicating kQ products obtained therefrom.

FIG. 4B is a graph illustrating results of the experiment on the power supply system described above, indicating ηmax obtained therefrom.

FIG. 5A is a graph illustrating results of an experiment performed for comparison with the power supply system described above, indicating kQ products obtained therefrom.

FIG. 5B is a graph illustrating results of the experiment performed for comparison with the power supply system described above, indicating ηmax obtained therefrom.

FIG. 6 is a sectional view illustrating another example of arrangement positions of the first power transmission electrode and the second power transmission electrode in the water channel and the first power reception electrode and the second power reception electrode in the floating mobile body (or the underwater mobile body) of the power supply system described above.

FIG. 7 is a sectional view illustrating still another example of arrangement positions of the first power transmission electrode and the second power transmission electrode in the water channel and the first power reception electrode and the second power reception electrode in the floating mobile body (or the underwater mobile body) of the power supply system described above.

FIG. 8 is a sectional view illustrating an outline of another power supply system for a floating mobile body or an underwater mobile body according to an embodiment of the present invention.

FIG. 9A is a sectional view taken along a section in a lengthwise direction of a water channel, illustrating an outline of still another power supply system for a floating mobile body or an underwater mobile body according to an embodiment of the present invention.

FIG. 9B is a sectional view taken along a section in a width direction (direction perpendicular to the lengthwise direction) of the water channel, illustrating an outline of the still another power supply system for the floating mobile body or the underwater mobile body according to the embodiment of the present invention.

FIG. 10 illustrates an equivalent circuit diagram of the power supply system illustrated in FIGS. 9A and 9B.

FIG. 11 is a sectional view taken along a section in a width direction (direction perpendicular to a lengthwise direction) of a water channel, illustrating a configuration for an experiment on the power supply system illustrated in FIGS. 9A and 9B.

FIG. 12 is a sectional view taken along a section in a width direction (direction perpendicular to a lengthwise direction) of a water channel, illustrating a configuration for an experiment on the power supply system illustrated in FIGS. 1A and 1B, which was performed in parallel with the experiment on the power supply system illustrated in FIGS. 9A and 9B.

FIG. 13A is a graph illustrating results of the experiments on the power supply systems illustrated in FIGS. 11 and 12, indicating kQ products obtained therefrom.

FIG. 13B is a graph illustrating results of the experiments on the power supply systems illustrated in FIGS. 11 and 12, indicating ηmax obtained therefrom.

### DETAILED DESCRIPTION

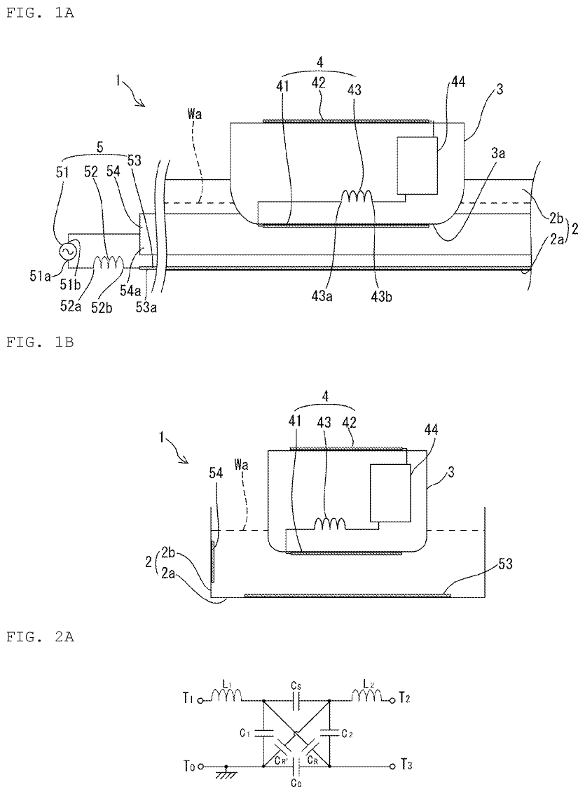

Hereinafter, an embodiment of the present invention will be described. As illustrated in FIGS. 1A and 1B, a power supply system 1 for a floating mobile body or an underwater mobile body according to the embodiment of the present invention can supply power in a non-contact manner from a power transmission apparatus 5 to a power reception apparatus 4 of a floating mobile body (or an underwater mobile body) 3 that moves on or under water in a water channel 2. It is not particularly distinguished whether the floating mobile body (or the underwater mobile body) 3 is a floating mobile body such as a ship or an underwater mobile body such as a submarine. However, in many cases, the floating mobile body 3 is a floating mobile body.

The power transmission apparatus 5 includes an alternating-current (AC) power source 51, a power transmission inductance element 52, a first power transmission electrode 53, and a second power transmission electrode 54.

The AC power source 51 has a first terminal 51a and a second terminal 51b and outputs an AC wave. While the frequency of the AC wave is not particularly limited, for example, a specific frequency within a range of 1 MHz to 10 MHz may be used.

One terminal 52a of the power transmission inductance element 52 is connected to the first terminal 51a of the AC power source 51, and the other terminal 52b of the power transmission inductance element 52 is connected to an end portion 53a of a first power transmission electrode 53, which will be described below. The power transmission inductance element 52 has a predetermined inductance value, and a coil can be normally used.

The first power transmission electrode 53 and a second power transmission electrode 54 are continuously extended along the water channel 2. The first power transmission electrode 53 and the second power transmission electrode 54 are provided apart from each other. A long metal plate (for example, a copper plate), a metal foil (for example, a copper foil), or the like can be used as the first power transmission electrode 53 and the second power transmission electrode 54. Further, to prevent corrosion or the like, the first power transmission electrode 53 and the second power transmission electrode 54 may be provided with a surface protective layer.

As described above, the end portion 53a of the first power transmission electrode 53 is connected to the other terminal 52b of the power transmission inductance element 52.

An end portion 54a of the second power transmission electrode 54 is connected to the second terminal 51b of the AC power source 51. The second power transmission electrode 54 (or the second terminal 51b of the AC power source 51) can be grounded.

The power reception apparatus 4 is mounted on the floating mobile body (or the underwater mobile body) 3. The power reception apparatus 4 has a first power reception electrode 41, a second power reception electrode 42, and a power reception inductance element 43.

The first power reception electrode 41 and the second power reception electrode 42 are provided apart from each other. A metal plate (for example, a copper plate), a metal foil (for example, a copper foil), or the like can be used as the first power reception electrode 41 and the second power reception electrode 42. One terminal 43a of the power reception inductance element 43 is connected to the first power reception electrode 41. The second power reception electrode 42 can be connected to a ground potential of the floating mobile body (or the underwater mobile body) 3. The other terminal 43b of the power reception inductance element 43 and the second power reception electrode 42 can be connected to a load 44 such as a rechargeable battery.

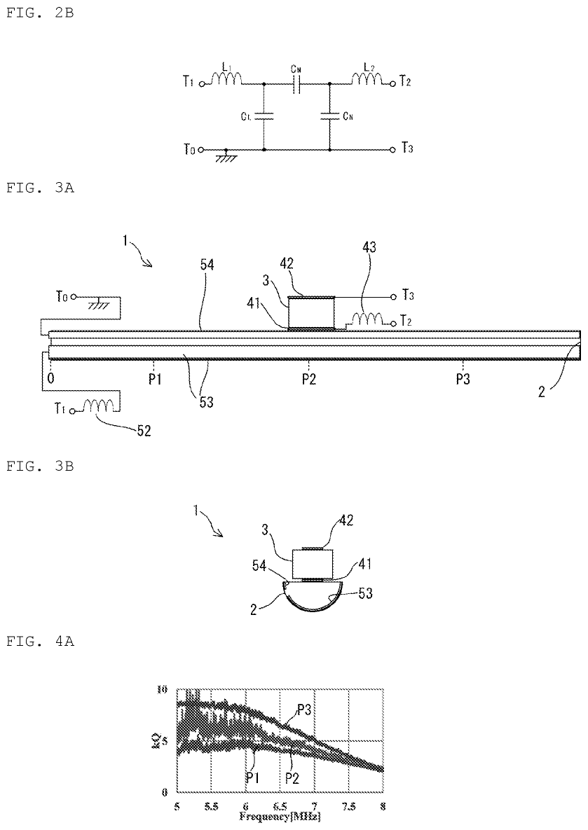

FIG. 2A illustrates an equivalent circuit diagram of the power supply system 1 having the configuration described above. C_{S} in FIG. 2A represents a capacitance value formed between the first power transmission electrode 53 and the first power reception electrode 41. C_{G} represents a capacitance value formed between the second power transmission electrode 54 and the second power reception electrode 42. C₁ represents a capacitance value formed between the first power transmission electrode 53 and the second power transmission electrode 54. C_{R} represents a capacitance value formed between the first power transmission electrode 53 and the second power reception electrode 42. C₂ represents a capacitance value formed between the first power reception electrode 41 and the second power reception electrode 42. C_{R′}represents a capacitance value formed between the first power reception electrode 41 and the second power transmission electrode 54. L₁ represents an inductance value of the power transmission inductance element 52. L₂ represents an inductance value of the power reception inductance element 43. T₁ and T₀ are terminals that receive AC waves from the AC power source 51, and T₂ and T₃ are terminals that output to the load 44.

Water Wa is present among each of the first power transmission electrode 53 and the second power transmission electrode 54 of the power transmission apparatus 5 and each of the first power reception electrode 41 and the second power reception electrode 42 of the power reception apparatus 4. Since the relative permittivity of the water Wa is approximately 80, C_{S}, C_{G}, C_{R}, and C_{R′}, in FIG. 2A have large capacitance values. Thus, a strong electric field coupling can be achieved between any of the first power transmission electrode 53 and the second power transmission electrode 54 of the power transmission apparatus 5 and any of the first power reception electrode 41 and the second power reception electrode 42 of the power reception apparatus 4, and even if there is a large distance therebetween, electric field coupling to a certain extent can be obtained.

FIG. 2B illustrates an equivalent circuit diagram further obtained from the equivalent circuit diagram illustrated in FIG. 2A. C_{L}, C_{M}, and C_{N} in FIG. 2B are calculated from C_{S}, C_{G}, C_{R}, and C_{R′}, described above as in the following equations (1), (2), and (3).

$${C}_{L} = {C}_{1} + \frac{{C}_{S} {C}_{R} + {C}_{G} {C}_{{R}^{′}} + 2 {C}_{R} {C}_{{R}^{′}}}{{C}_{S} + {C}_{G} + {C}_{R} + {C}_{{R}^{′}}} \qquad ( 1 )$$

$${C}_{M} = \frac{{C}_{S} {C}_{G} - {C}_{R} {C}_{{R}^{′}}}{{C}_{S} + {C}_{G} + {C}_{R} + {C}_{{R}^{′}}} \qquad ( 2 )$$

$${C}_{N} = {C}_{2} + \frac{{C}_{S} {C}_{{R}^{′}} + {C}_{G} {C}_{R} + 2 {C}_{R} {C}_{{R}^{′}}}{{C}_{S} + {C}_{G} + {C}_{R} + {C}_{{R}^{′}}} \qquad ( 3 )$$

Thus, in FIG. 2B, for example, by appropriately setting L₁ , L₁ and C_{L} can form a resonance circuit that resonates at the frequency of the AC wave output from the AC power source 51. Likewise, by appropriately setting L₂, L₂ and C_{N} can form a resonance circuit that resonates at the frequency of the AC wave output from the AC power source 51. In addition, the resonance circuit formed by L₁ and C_{L} and the resonance circuit formed by L₂ and C_{N} are strongly coupled by a large capacitance value C_{M}. Thus, a large coupling coefficient k is obtained.

As described above, since the first power transmission electrode 53 and the second power transmission electrode 54 are basically provided in the water channel 2, the power supply system 1 for the floating mobile body or the underwater mobile body has a simple configuration and can easily supply power over a long moving distance.

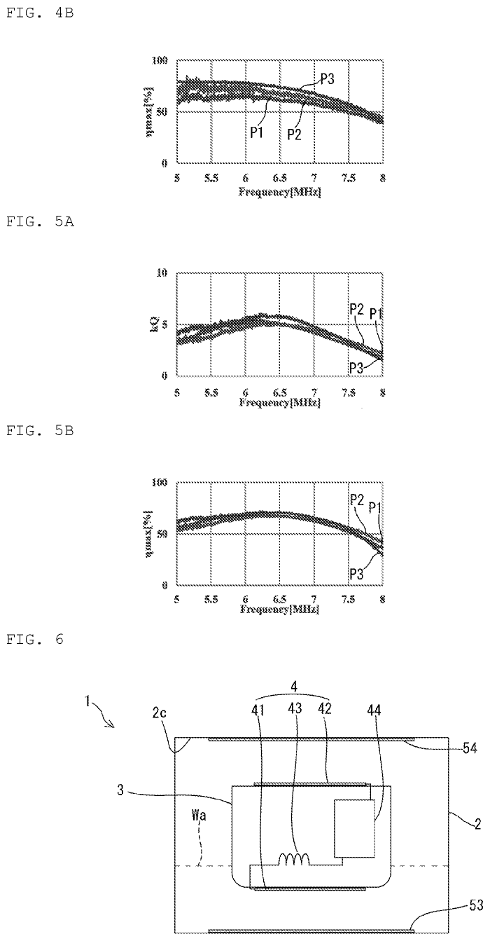

Next, an experiment conducted by the inventor of the present application will be described. FIGS. 3A and 3B illustrate a configuration for the experiment conducted by the inventor of the present application. The water channel 2 shaped in a gutter having a semicircular cross section with a diameter of 11 cm was used. The first power transmission electrode 53 was an 80-μm-thick copper-foil tape having a width of 9 cm and was attached to the bottom surface of the water channel 2. The second power transmission electrode 54 was the copper-foil tape having a width of 2.5 cm and was attached to the bottom surface of the water channel 2, aligned with the first power transmission electrode 53 with a 1-cm spacing therebetween. The first power reception electrode 41 and the second power reception electrode 42 were the copper-foil tapes each having a length of 9 cm (in a lengthwise direction of the water channel 2 ) and a width of 4.5 cm and were attached to the bottom surface and the upper surface of the floating mobile body (or the underwater mobile body) 3, respectively. The water channel 2 was filled with water Wa, which was tap water. The floating mobile body (or the underwater mobile body) 3 was placed 20 cm (position P1), 50 cm (position P2), and 80 cm (position P3) apart from an end portion of the first power transmission electrode 53, and a vector network analyzer (VNA) was connected to T₀, T₁, T₂, and T₃ to examine transmission characteristics.

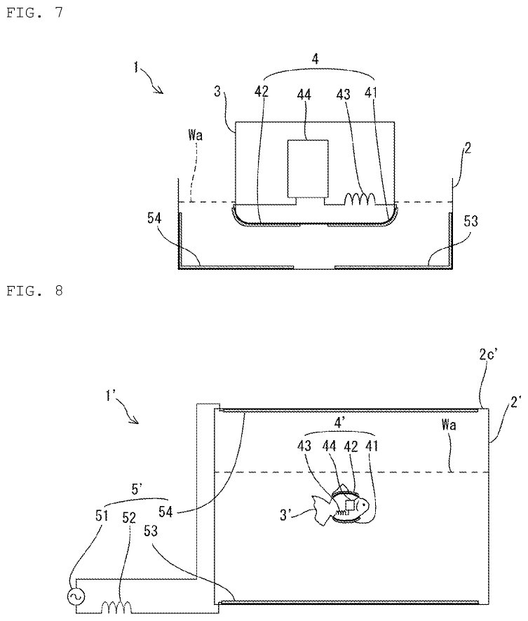

FIGS. 4A and 4B illustrate experimental results on transmission characteristics obtained from the experiment using water conducted by the inventor of the present application. This experiment corresponds to the power supply system 1. In addition, to compare with the results illustrated in FIGS. 4A and 4B, an experiment using no water was conducted by the inventor of the present application. FIGS. 5A and 5B illustrate experimental results on transmission characteristics obtained from the experiment using no water. This experiment corresponds to a system configured on the ground. As transmission characteristics, a kQ product, which is a product of the coupling coefficient k described above and a no-load Q value of a resonance circuit, and maximum transmission efficiency ηmax, which is derived from the kQ product, were obtained. In the experiment using no water, the vertical position of the floating mobile body 3 was adjusted by using styrene foam, instead of using the water Wa.

According to these experimental results, in the case of using water, when the position was changed to P1, P2, and P3, the corresponding kQ products (and ηmax) greatly changed, compared to those in the case of using no water, and the lowest value was obtained at the position P1. When at the position P1, for example, at the frequency of 6.78 MHz, the kQ product and ηmax in the case of using water were approximately 3.8 and 60%, respectively, and the kQ product and ηmax in the case of using no water were approximately 4.2, and 65%, respectively. That is, the kQ product and the maximum transmission efficiency ηmax in the case of using water were approximately equivalent to those in the case of using no water.

Thus, the above experimental results suggest that, compared with the system configured on the ground, the power supply system 1 compensates for a decrease in the no-load Q value due to the presence of the water Wa by an increase in the coupling coefficient k and can obtain at least approximately the same kQ product and the maximum transmission efficiency ηmax. In addition, in the water channel 2, in terms of the no-load Q value, the power supply system 1 is more suitably used in a water channel of fresh water or water Wa having a small salt content than in a water channel of seawater or water Wa having a large salt content, which is likely to cause a decrease in the no-load Q value.

Next, arrangement of the first power transmission electrode 53 and the second power transmission electrode 54 in the water channel 2 and arrangement of the first power reception electrode 41 and the second power reception electrode 42 in the floating mobile body (or the underwater mobile body) 3 will be described.

While not particularly limited, the first power transmission electrode 53 is typically disposed on a bottom portion 2a of the water channel 2 (see FIGS. 1A and 1B). The second power transmission electrode 54 may be disposed on a side portion 2b (see FIGS. 1A and 1B) or may be disposed on the bottom portion 2a alongside the first power transmission electrode 53. In addition, an area of the second power transmission electrode 54 may be set smaller than that of the first power transmission electrode 53. This can reduce the capacitance value C_{R′}(parasitic capacitance) formed between the second power transmission electrode 54 and the first power reception electrode 41.

The first power reception electrode 41 is disposed so as to face the first power transmission electrode 53 in the water channel 2. Thus, the first power reception electrode 41 is typically disposed on the bottom portion 3a of the floating mobile body (or the underwater mobile body) 3 so that the first power reception electrode 41 can face the first power transmission electrode 53 in the water channel 2 via the water Wa in a wide area. This can increase the capacitance value C_{S} formed between the first power reception electrode 41 and the first power transmission electrode 53.

Further, the second power reception electrode 42 can be disposed above the first power reception electrode 41. This can secure the capacitance value C_{G} formed between the second power reception electrode 42 and the second power transmission electrode 54 to a certain extent, while reducing the capacitance value C_{R} (parasitic capacitance) formed between the second power reception electrode 42 and the first power transmission electrode 53.

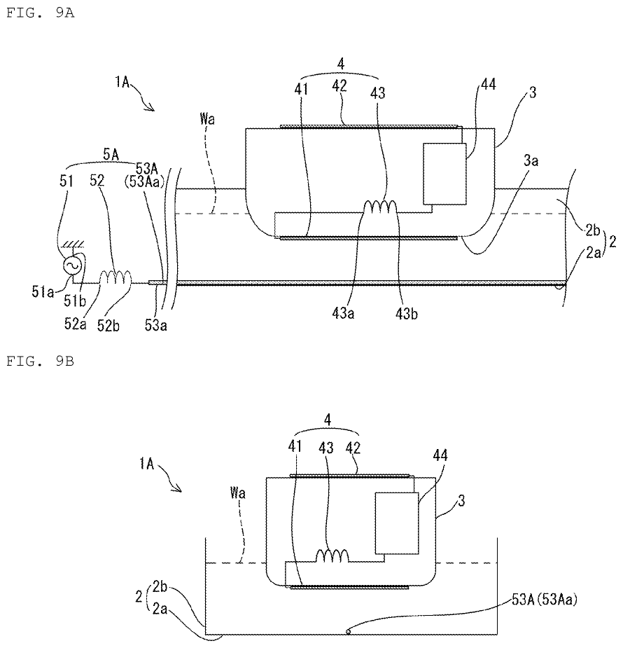

As illustrated in FIG. 6, in a case where the water channel 2 has a tunnel, the second power transmission electrode 54 may be disposed on a ceiling portion 2c of the tunnel, and as illustrated in FIG. 7, the first power transmission electrode 53 and the second power transmission electrode 54 may be arranged alongside each other, and the first power reception electrode 41 and the second power reception electrode 42 may be arranged alongside each other. In this way, the first power reception electrode 41 can be disposed facing the first power transmission electrode 53, and the second power reception electrode 42 can be disposed facing the second power transmission electrode 54. This arrangement can increase both the capacitance value C_{S} formed between the first power reception electrode 41 and the first power transmission electrode 53 and the capacitance value C_{G} formed between the second power reception electrode 42 and the second power transmission electrode 54.

Next, a power supply system 1′ for a floating mobile body or an underwater mobile body according to an embodiment of the present invention will be described. As illustrated in FIG. 8, the power supply system 1′ can supply power in a non-contact manner from a power transmission apparatus 5′ to a power reception apparatus 4′ of a floating mobile body (or an underwater mobile body) 3′ that moves on or under water in a water tank 2′. The floating mobile body (or the underwater mobile body) 3′ may be a swimming body of various shapes such as a fish type, a ship type, and a submarine type, and whether the swimming body is a floating mobile body or an underwater mobile body is not particularly distinguished.

The power transmission apparatus 5′ includes an AC power source 51, a power transmission inductance element 52, a first power transmission electrode 53, and a second power transmission electrode 54, which are similar to those included in the power transmission apparatus 5 described above, while the scale of the individual components may be different. The power reception apparatus 4′ includes a first power reception electrode 41, a second power reception electrode 42, and a power reception inductance element 43, which are similar to those described above, while the scale of the individual components may be different. The first power transmission electrode 53 and the second power transmission electrode 54 have sizes and shapes suitable for the water tank 2′.

It is preferable to provide the second power transmission electrode 54 of the power transmission apparatus 5′ in an area including a ceiling portion 2c′ (for example, only on the ceiling portion 2c′ or in an area including the ceiling portion 2c′ and a part of a side portion extended therefrom) of the water tank 2′ and provide the second power reception electrode 42 of the power reception apparatus 4′ above the first power reception electrode 41 (for example, on a back portion of the fish type).

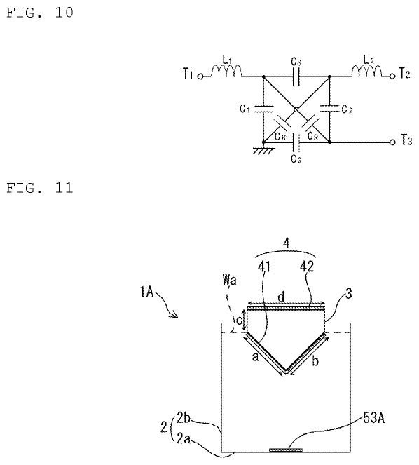

Next, a power supply system 1A for a floating mobile body or an underwater mobile body according to an embodiment of the present invention will be described. As illustrated in FIGS. 9A and 9B, the power supply system 1A can supply power in a non-contact manner from a power transmission apparatus 5A to a power reception apparatus 4 of a floating mobile body (or an underwater mobile body) 3 that moves on or under water in a water channel 2.

A configuration of the power reception apparatus 4 in the power supply system 1A is similar to that of the power reception apparatus 4 in the power supply system 1. In the power supply system 1A, a second power reception electrode 42 is disposed vertically above a first power reception electrode 41.

The power transmission apparatus 5A includes an AC power source 51, a power transmission inductance element 52, and a first power transmission electrode 53A. The AC power source 51 and the power transmission inductance element 52 are similar to the AC power source 51 and the power transmission inductance element 52 in the power supply system 1. However, in the power supply system 1A, a second terminal 51b of the AC power source 51 is not connected to an electrode such as the second power transmission electrode 54. The second terminal 51b can be grounded.

In the power supply system 1A, only the first power transmission electrode 53A is provided along the water channel 2, and the first power transmission electrode 53A includes an electric wire (or a cable formed by bundling a plurality of electric wires) 53Aa. The electric wire (or the cable) 53Aa has a diameter smaller than that of the first power reception electrode 41. The electric wire (or the cable) 53Aa may be provided with a surface protection layer therearound to prevent corrosion or the like. The first power reception electrode 41 is disposed vertically above the electric wire (or the cable) 53Aa so as to face the electric wire 53Aa and supplied with power from the electric wire (or the cable) 53Aa in a non-contact manner.

FIG. 10 illustrates an equivalent circuit diagram of the power supply system 1A. Since only the first power transmission electrode 53A is provided in the water channel 2, and an electrode corresponding to the second power transmission electrode 54 of the power supply system 1 is not provided, C_{G}, C₁, and C_{R′}, are capacitance values generated with the ground. In addition, since the second power reception electrode 42 is disposed vertically above the first power reception electrode 41, and the first power reception electrode 41 is disposed vertically above the electric wire (or the cable) 53Aa with a small diameter, the impact of the electric wire (or the cable) 53Aa on the second power reception electrode 42 is extremely small so that C_{R} can be made extremely small.

Next, an experiment conducted by the inventor of the present application will be described. FIG. 11 illustrates a configuration for the experiment on the power supply system 1A conducted by the inventor of the present application. The water channel 2 had a cross section having a width of 15 cm and a height of 15 cm and had a length of 100 cm in a lengthwise direction (direction in which the water channel 2 extends). The water depth was 14 cm. The floating mobile body (or the underwater mobile body) 3 had a bottom surface having a triangular shape (two sides a and b each had a length of 5 cm), a side surface having a height c of 2 cm, and an upper surface having a width d of 7 cm when viewed in section, and had a length of 15 cm in a lengthwise direction (direction in which the water channel 2 extends). The floating mobile body (or the underwater mobile body) 3 was supported from the bottom surface of the water channel 2. Tap water having a conductivity of approximately 12 mS/m was used as the water Wa. The distance from the lowest point of the bottom surface of the floating mobile body (or the underwater mobile body) 3 to the bottom surface of the water channel 2 was approximately 10 cm.

In place of the electric wire (or the cable) 53Aa, a copper-foil tape having a width of 2.5 cm was used as the first power transmission electrode 53A, and the first power transmission electrode 53A was attached to the bottom surface of the water channel 2. The first power reception electrode 41 was a copper-foil tape and was attached to the entire bottom surface of the floating mobile body (or the underwater mobile body) 3. The second power reception electrode 42 was a copper-foil tape and was attached to the entire upper surface of the floating mobile body (or the underwater mobile body) 3. All the above copper-foil tapes had a thickness of 80 μm.

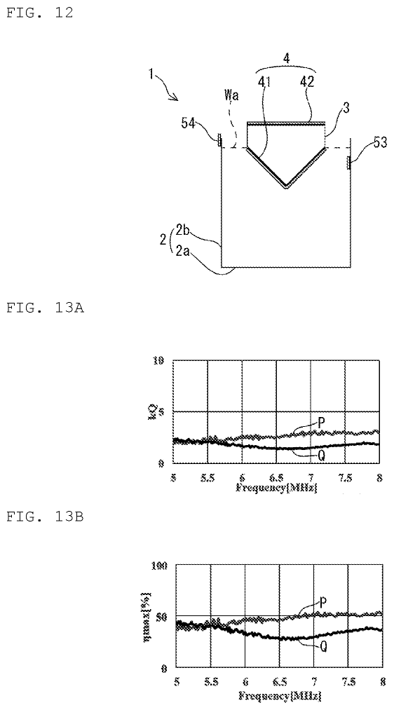

FIG. 12 illustrates a configuration for an experiment on the power supply system 1, which was conducted in parallel with the experiment on the power supply system 1A. The configuration for the experiment on the power supply system 1 included the first power transmission electrode 53 and the second power transmission electrode 54, in place of the first power transmission electrode 53A in the power supply system 1A. The first power transmission electrode 53 was a copper-foil tape having a width of 1.3 cm and was attached to a side surface of the water channel 2 at a height of 12 cm from a bottom surface thereof. The second power transmission electrode 54 was a copper-foil tape having a width of 1.3 cm and was attached to the other side surface of the water channel 2 at a position above the water surface.

FIGS. 13A and 13B illustrate experimental results on transmission characteristics obtained from the experiments performed on the power supply system 1A and the power supply system 1. As transmission characteristics, a kQ product and maximum transmission efficiency ηmax derived from the kQ product were obtained. In FIGS. 13A and 13B, Q indicates the experimental result of the power supply system 1A, and P indicates the experimental result of the power supply system 1.

According to the experimental results, for example, at the frequency of 6.78 MHz, the kQ product and ηmax were approximately 1.5 and 28%, respectively, in the power supply system 1A and approximately 2.7 and 48%, respectively, in the power supply system 1. These values do not indicate significant decrease and fall within a range in which practical use is possible.

In the power supply system 1A, since only the first power transmission electrode 53A is provided in the water channel 2, the system can be greatly simplified. Further, since the first power transmission electrode 53A is provided on the bottom surface in the water channel 2, the system can be easily applied to the water channel 2 (lake, river, or the like) where there is practically no side surface.

While the power supply systems for a floating mobile body or an underwater mobile body according to the embodiments of the present invention have thus been described, the present invention is not limited to the embodiments described above, and various design changes can be made within the scope of the matters described in the claims.

### REFERENCE SIGNS LIST

1, 1′, 1A Power supply system for floating mobile body or underwater mobile body

2 Water channel

2a Bottom portion of water channel

2b Side portion of water channel

2c Ceiling portion of water channel

2′ Water tank

2c′ Ceiling portion of water tank

3, 3′ Floating mobile body (or underwater mobile body)

3a Bottom portion of floating mobile body (or underwater mobile body)

4, 4′ Power reception apparatus

41 First power reception electrode

42 Second power reception electrode

43 Power reception inductance element

43a One terminal of power reception inductance element

43b Other terminal of power reception inductance element

44 Load

5, 5′, 5A Power transmission apparatus

51 AC power source

51a First terminal of AC power source

51b Second terminal of AC power source

52 Power transmission inductance element

52a One terminal of power transmission inductance element

52b Other terminal of power transmission inductance element

53, 53A First power transmission electrode

53a End portion of first power transmission electrode

53Aa Electric wire (or cable)

54 Second power transmission electrode

54a End portion of second power transmission electrode

Wa Water

1. A power supply system for a floating mobile body or an underwater mobile body that moves on or under water in a water channel or a water tank, the power supply system being configured to supply, in a non-contact manner, power from a power transmission apparatus to a power reception apparatus of the floating mobile body or the underwater mobile body, wherein
the power transmission apparatus includes
an AC power source that includes a first terminal and a second terminal, and outputs an AC power wave,
a power transmission inductance element having one terminal connected to the first terminal, and
a first power transmission electrode provided in the water channel or the water tank, the first power transmission electrode having an end portion connected to another terminal of the power transmission inductance element, and
the power reception apparatus includes
a first power reception electrode,
a second power reception electrode provided apart from the first power reception electrode, and
a power reception inductance element connected to the first power reception electrode.

2. The power supply system for a floating mobile body or an underwater mobile body according to claim 1, wherein the power transmission apparatus further includes a second power transmission electrode provided apart from the first power transmission electrode in the water channel or the water tank, the second power transmission electrode having an end portion connected to the second terminal of the AC power source.

3. The power supply system for a floating mobile body or an underwater mobile body according to claim 2, wherein the second power transmission electrode or the second terminal is grounded.

4. The power supply system for a floating mobile body or an underwater mobile body according to claim 1, wherein
the first power reception electrode is disposed so as to face the first power transmission electrode in the water channel, and
the second power reception electrode is disposed above the first power reception electrode.

5. The power supply system for a floating mobile body or an underwater mobile body according to claim 2, wherein
the first power reception electrode is disposed so as to face the first power transmission electrode, and
the second power reception electrode is disposed so as to face the second power transmission electrode.

6. The power supply system for a floating mobile body or an underwater mobile body according to claim 1, wherein
the water channel is provided with only the first power transmission electrode,
the first power transmission electrode includes an electric wire or a cable formed by bundling a plurality of electric wires,
the electric wire or the cable has a diameter smaller than that of the first power reception electrode,
the first power reception electrode is disposed so as to face the electric wire or the cable, and
the second power reception electrode is disposed vertically above the first power reception electrode.

7. The power supply system for a floating mobile body or an underwater mobile body according to claim 6, wherein the second terminal of the AC power source is grounded.

8. The power supply system for a floating mobile body or an underwater mobile body according to claim 2, wherein
the first power reception electrode is disposed so as to face the first power transmission electrode in the water channel, and
the second power reception electrode is disposed above the first power reception electrode.

9. The power supply system for a floating mobile body or an underwater mobile body according to claim 3, wherein
the first power reception electrode is disposed so as to face the first power transmission electrode in the water channel, and
the second power reception electrode is disposed above the first power reception electrode.

10. The power supply system for a floating mobile body or an underwater mobile body according to claim 3, wherein
the first power reception electrode is disposed so as to face the first power transmission electrode, and
the second power reception electrode is disposed so as to face the second power transmission electrode.
